(19) United States
(12) Patent Application Publication
(10) Pub. No.: US 2026/0037819 A1
(43) Pub. Date: Feb. 5, 2026

(54) METHOD AND SYSTEM FOR GENERALIZED ACTIVE LEARNING BY NEURAL NETWORK EMBEDDING-BASED CLUSTERING ON VISION DATASETS

(71) Applicant: NORTHROP GRUMMAN SYSTEMS CORPORATION, Falls Church, VA (US)

(72) Inventors: Ruksana Kabealo, Melbourne, FL (US); David R. Elliott, Melbourne, FL (US)

(73) Assignee: NORTHROP GRUMMAN SYSTEMS CORPORATION, Falls Church, VA (US)

(21) Appl. No.: 18/789,856

(22) Filed: Jul. 31, 2024

(51) Int. Cl. G06N 3/091

(52) U.S. Cl. CPC G06N 3/091

(57) ABSTRACT

The method and system for data pruning use the novel heuristic of weighting the selection of images by an internal diversity metric, such as the radius of the cluster, allowing more images to be sampled from clusters that are more internally diverse. This heuristic is added to improve the overall diversity of the selected images and to prevent the over-representation of similar images. By sampling more images from clusters that are more internally diverse, the approach is able to better represent the overall distribution of the data, improving the quality of the resulting pruned dataset.

### BACKGROUND

Modern machine learning (ML) based computer vision techniques have made great strides across a wide range of mission-critical tasks, achieving near-human or better-than-human levels of performance in object detection and classification, multi-object tracking, activity recognition, and more. However, the success of these methods generally comes with the cost of requiring immense amounts of annotated training data. High-quality, publicly available, annotated datasets are hard to come by and, when available, are often not mission-specific enough to be used exclusively. This lack of sufficiently good data frequently leads to internal, mission-specific data collection and an abundance of data that requires annotation. Human annotation efforts are expensive and time-consuming, and their cost grows exponentially with the size of the dataset being annotated.

Active Learning (ΔL) is a subfield of machine learning that focuses on maximizing a model's performance gain while requiring the least amount of labeled data necessary. Active learning can be implemented through either model-based methods or data-based methods, such as data pruning. Data pruning aims to reduce the size of a dataset while preserving its representative and discriminative properties. In addition to reducing manual annotation costs, data pruning can also reduce the storage cost of the data as well as the computation cost of models trained on the data. Finally, data pruning can improve the interpretability and generalization of models trained on the data.

Various approaches to performing data pruning have been explored, which includes Forgetting Scores, Memorization Scores, and L2-Norm (EL2N) Scores.

Forgetting Scores, proposed in 2018, are computed for each training sample during training time by quantifying the number of times during training that a classifier switches from making a correct classification decision for a sample to an incorrect one. That is, forgetting scores quantify the number of times that a training sample was “forgotten.” Samples with low forgetting scores are easily learned and, therefore, can be pruned.

Memorization Scores, proposed in 2020, are also computed per training sample and correspond to how much the probability of predicting the correct label at each test sample increases when this training sample is present in the training set relative to when it is absent. Samples with low memorization scores are considered redundant with the rest of the data. Although using memorization scores to inform data pruning has been recently suggested in the literature, the high cost of computing memorization scores has prevented rigorous investigation of this approach.

EL2N Scores, proposed in 2021, are computed by training small ensembles of neural networks for a short amount of time and using these ensembles to compute the average L2 norm of the error vector for each training sample. The samples with the smallest error are easily learned and, therefore, can be pruned. Although powerful, these metrics all rely on the existence of labels and can only be applied to annotated data. This is a huge disadvantage, as high-quality, publicly available, annotated datasets are hard to come by, and collecting ground truth alongside internally collected data is often infeasible.

### SUMMARY

The disclosed invention aims to reduce the annotation effort required for unlabeled vision data by down-selecting this data to a diverse subset, with minimal interaction from the user. This will drastically reduce the amount of data that requires annotation, therefore reducing the amount of time and effort before data is ready for ingestion by a model. This will facilitate a more rapid turnaround of models.

The disclosed invention provides an Active Learning Python module that uses data pruning to select a diverse subset of a dataset. The module uses OpenCLIP, an open-source replication of OpenAI's CLIP (Contrastive Language-Image Pre-training) Vision Transformer (ViT), trained on up to two billion images, to compute image embeddings from a vision dataset. The module then uses a clustering algorithm, such as a K-means clustering algorithm combined with a user-defined cluster initialization value, to group these image embeddings into clusters, where each cluster represents a group of images with highly similar content. To create a diverse, pruned subset of the original dataset, data points are randomly sampled from these clusters using a novel heuristic: a metric of internal diversity for the cluster, such as the cluster's radius, is used to determine the number of images to select from that cluster, resulting in a more representative pruned subset.

These advantages and others are achieved, for example, by a method for data pruning to create a diverse subset of an initial dataset to train Active Learning (AL) models. The method includes the steps of preparing an initial dataset of images to be pruned, creating, via an image encoder, image embeddings of images of the initial dataset of images, performing clustering with the image embeddings to create a plurality of clusters that contain the image embeddings, setting a target selection number of images which is to be contained in the diverse subset, obtaining a selection number for each cluster based on internal diversity of clusters, selecting images among images in each cluster based on the selection number for each cluster, generating the diverse subset with the selected images; and training the Active Learning (AL) models with the generated diverse subset. The image embeddings include numeric representations of the images and are constructed to represent similarities of the images. The internal diversity represents a variety of distinctions or differences within otherwise clustered or grouped images.

A metric of the internal diversity may include the radius of each cluster. The obtaining of the selection number for each cluster may include computing the target selection number as weighted by a radius of the cluster. The radius of the cluster may be a distance between the center of the cluster and the farthest image embedding contained in the cluster. The image embeddings may include multi-dimensional vectors. The selecting of images among images in each cluster may include randomly selecting images from each cluster by the selection number. The performing of clustering may include the steps of setting a number of clusters, initializing the centers of clusters, assigning each image embedding to a cluster based on a distance between the image embedding and the center of the cluster, recalculating the centers of the clusters as a mean value of the image embeddings assigned to each cluster, updating the assignment of each image embedding in the clusters based on the recalculated centers of the clusters, and repeating recalculating the centers of the clusters and updating the assignment of each image embedding until there is no change in the assignment of the image embeddings to the clusters or until predetermined convergence criteria are met.

These advantages and others are achieved, for example, by a system for data pruning to create a diverse subset to train Active Learning (AL) models. The system includes at least one image encoder that may store image embeddings of a plurality of images and at least one computing device coupled to the at least one image encoder to create, via the embedding model, image embeddings of images of an initial dataset of images. The image embeddings include numeric representations of the images and are constructed to condense the complex images into compact representations that can be easily compared to quantify the similarities of the images. The at least one computing device includes at least one processor and one or more non-transitory computer readable media including instructions that cause the at least one processor to execute operations for data pruning to create the diverse subset. The operations include receiving the initial dataset of images to be pruned, creating, via the image encoder, image embeddings of images of the initial dataset of images, performing clustering with the image embeddings to create a plurality of clusters that contain the image embeddings. setting a target selection number of images which is to be contained in the diverse subset, obtaining a selection number for each cluster based on internal diversity of clusters, selecting images among images in each cluster based on the selection number for each cluster, generating the diverse subset with the selected images, and training the Active Learning (AL) models with the generated diverse subset. The internal diversity represents a variety of distinctions or differences within otherwise clustered or grouped images.

### BRIEF DESCRIPTION OF THE DRAWINGS

The preferred embodiments described herein and illustrated by the drawings hereinafter are included to illustrate and not to limit the invention, where like designations denote like elements.

FIG. 1 is a workflow diagram of a method of the disclosed invention for data pruning to create a diverse subset of images from an initial dataset of images to train Active Learning models.

FIGS. 2A-2B are exemplary diagrams illustrating an image embedding process that is used in the method and system of the disclosed invention.

FIGS. 3A-3B are exemplary diagrams illustrating how the image embeddings can be used to group the images based on their similarities in the clustering process.

FIG. 3C is an example of image embeddings grouped based on similarity.

FIG. 4 is a workflow diagram of a clustering method that may be used for the method and system of the disclosed invention.

FIGS. 5A-5B are exemplary diagrams illustrating a definition of a radius of a cluster.

FIG. 6 shows an exemplary diagram illustrating an Active Learning (AL) loop.

FIG. 7 is a diagram of a system of the disclosed invention for data pruning to create a diverse subset of images from an initial dataset of images to train Active Learning models.

FIG. 8A shows an example of a group of highly similar images.

FIG. 8B shows an example of a group of diverse images obtained by using the method and system of the disclosed invention. These images were obtained from the same initial dataset that the images in FIG. 8A were obtained from.

FIG. 8C shows a chart showing performance (mAP) of a YoloV5N model as trained on variously sized diverse subsets of an internal twenty thousand image dataset using the method and system of the disclosed invention.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

The method and system of the disclosed invention selects a diverse subset from a dataset of images. A straightforward approach to choosing a diverse subset from a dataset of images is to group images based on their similarity and then select a few images from each group. The method and system of the disclosed invention perform three phases to carry out this approach programmatically: embedding, clustering, and selecting.

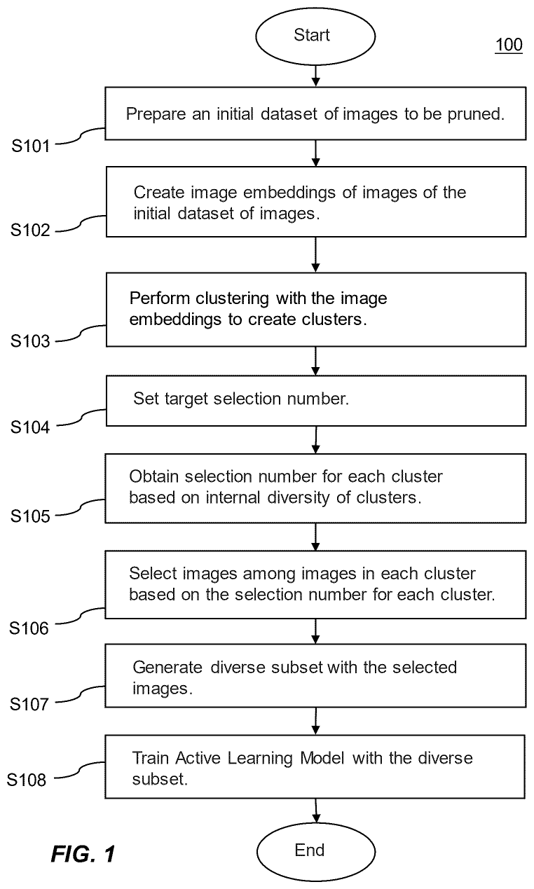

With reference to FIG. 1, shown is a workflow diagram of a method 100 of the disclosed invention for data pruning to create a diverse subset of images from an initial dataset of images to train Active Learning models. The method 100 to create a diverse subset of selected images is a type of data pruning process that can be used for Active Learning (AL) models. Active Learning focuses on maximizing a model's performance gain while requiring the least amount of labeled data necessary. Active Learning can be implemented through data-based methods, such as data pruning. The method starts with preparing an initial dataset of images that may include a large number of images, block S101. Once the initial images are prepared, image embeddings are created from the initial images, block S102. Details of the image embedding process are described below.

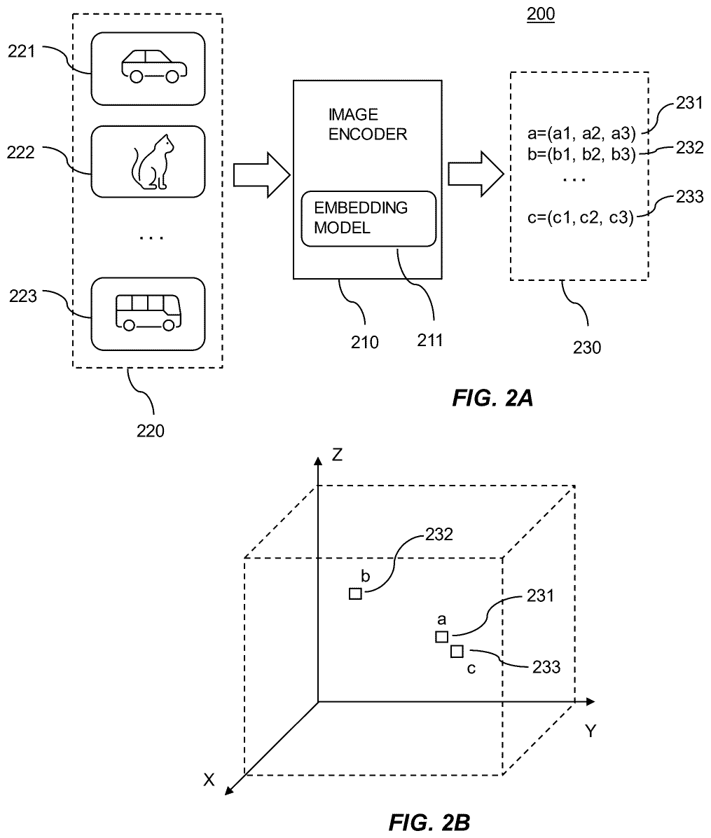

With reference to FIGS. 2A-2B, shown are exemplary diagrams illustrating the image embedding process 200 that is used in the disclosed invention. In the embedding process 200, in order to programmatically compare the similarity of images, images 221-223 in the initial dataset of images 220 are converted into image embeddings 230 using an image encoder 210. Image embeddings 230 are numeric representations of the images 220 that capture the semantic information of images 220. The numeric representations of the images 220 may be low dimensional vectors. The similarity between image embeddings can be measured simply, for example, by measuring the distance between the image embeddings.

The image encoder 210 receives raw images 221-223 and converts the received images 221-223 to image embeddings 231-233. The raw images 221-223 are images of the initial image set 220 prepared in the step S101 and may include a large number of various images of objects 6 and/or scenes. The image encoder 210 may use embedding model 211 to compute the image embeddings 231-233 of the images 221-223. Embedding models are specifically developed algorithms that are trained to encapsulate various complex modalities of information including image, text and/or audio information into simpler representations in a multi-dimensional (typically lower dimensional) space. The embedding model 211 may be built, for example, by passing a large amount of labeled image data to a neural network. By using the embedding model 211, the image encoder 210 provides image embeddings 231-233 that correspond to the images 221-223, respectively.

FIGS. 2A-2B show the image embeddings 231-233 represented as three-dimensional vectors. Vector image embeddings 231-233 are numerical representations that capture the relationships and meaning of the images 221-223. The vector embeddings 231-233 may be positioned in three-dimensional coordinates, as shown in FIG. 2B. The image embeddings 231, of images 221, 223 that share certain similarities are positioned closer to each other than to the image embedding 232 of less similar image 222. In this way, similarities and dissimilarities of images can be easily quantified by using the image embeddings. The examples shown in FIGS. 2A-2B show three-dimensional vector image embeddings for illustration purposes. However, the image embeddings may be any dimensional vectors or numeric representations based on the embedding models that are used to generate the image embeddings.

An example of the image encoder is from an OpenCLIP model. OpenCLIP is an open-source replication of OpenAI's CLIP (Contrastive Language-Image Pre-training) Vision Transformer (ViT), trained on up to two billion images, to compute image embeddings from a vision dataset. CLIP is a state-of-the-art method for unifying image and textual information by pre-training a large-scale neural network on a diverse range of image-text tasks. CLIP jointly trains an image encoder and a text encoder to predict the correct pairings of a batch of (image, text) training samples. The learned text encoder synthesizes a zero-shot linear classifier by embedding the names or descriptions of the target dataset's classes. Because they learn a wide range of visual concepts directly from natural language, CLIP models are flexible and general and, therefore, can be applied to nearly arbitrary visual classification tasks.

OpenCLIP yields models with slightly better performance than OpenAI's CLIP. Specifically, the image encoder from the CLIP-ViT-B-32-laion2B-s34B-b79K model may be used for the image encoder. CLIP-VIT-B-32-laion2B-s34B-b79K is a CLIP VIT B/32 OpenCLIP model trained on LAION-2B (a dataset of 2 billion CLIP-filtered English image-text pairs). HuggingFace's Transformers library is leveraged to implement the OpenCLIP model.

Once a metric for comparing images, such as the image embeddings described above, is established, the next step is to group these images based on their similarities. One approach is to use a clustering algorithm. Clustering is an unsupervised machine learning technique that groups similar data points into clusters based on similarity or a distance metric. Once image embeddings are obtained, a clustering process with the image embeddings is performed to create clusters, block S103. The number of clusters to create, which is k, may be pre-defined or may be determined by the clustering algorithm. For example, a clustering algorithm such as Density-Based Spatial Clustering of Applications with Noise (DBSCAN) estimates an appropriate number of clusters to produce as part of the algorithm itself. In this case, the number of clusters the algorithm has produced can be used for the clustering process in step S103. The number of clusters k may be given as a percentage of the total number of images in the initial dataset of images. Once the number of clusters k is determined, a clustering process with the image embeddings is performed to create k clusters in step S103. An example of the clustering process performed using the image embeddings is described below.

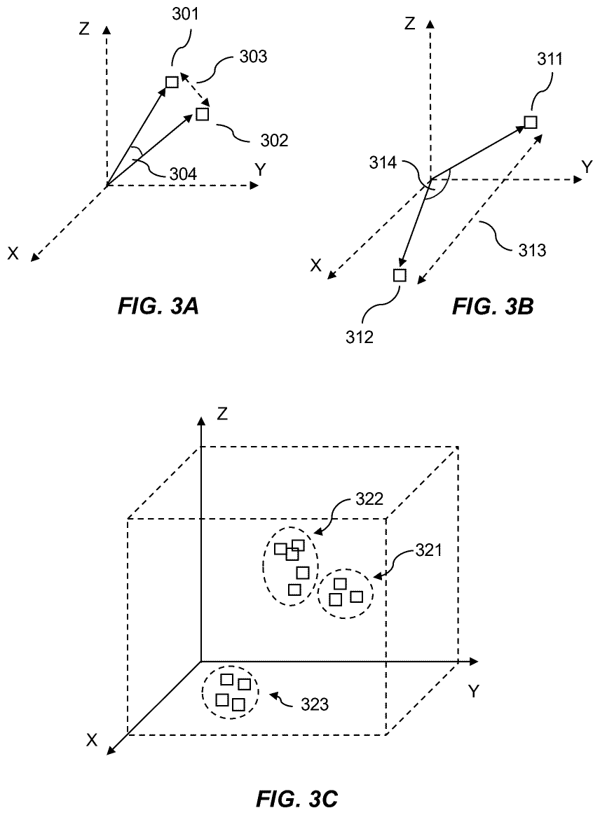

With reference to FIGS. 3A-3B, shown are exemplary diagrams illustrating how the image embeddings can be used to group the images based on their similarities. With reference to FIG. 3C, shown is an example of image embeddings grouped based on similarity. By comparing image embeddings (vectors), similarity between two images can be determined. FIG. 3A shows two image embeddings 301, 302 that are positioned closely to one another, and FIG. 3B shows two image embeddings 311, 312 that are positioned far away from one another. The distance 303 between the two image embeddings 301 and 302 is smaller than the distance 313 between the two image embeddings 311 and 312. The distance between the image embeddings may be one of the metrics used to quantify similarity between the corresponding images. Image embeddings with smaller distance therebetween may have certain similarities.

An example of a distance metric is the cosine similarity between the vector image embeddings based on the angle 304, 314 between the vectors. In this case, the vector image embeddings 301, 302, 311, 312 may be normalized to ensure that the cosine similarity measures the angular distance between vectors. A cosine similarity value of one (1) indicates a high degree of similarity while a cosine similarity value of negative one (−1) indicates dissimilarity. The type of distance metric and criteria for determining similarities may be predetermined before the clustering process begins.

The distance metric between image embeddings provides a quantitative representation of image similarity. For example, when the distance or the cosine similarity value between two image embeddings falls within a certain range, the two images may be considered to have high similarity. By using a clustering algorithm, the image embeddings can be grouped in clusters 321, 322, 323, as shown in FIG. 3C, based on criteria set for the distance metric. Images in the same cluster may be considered as sharing certain similarities.

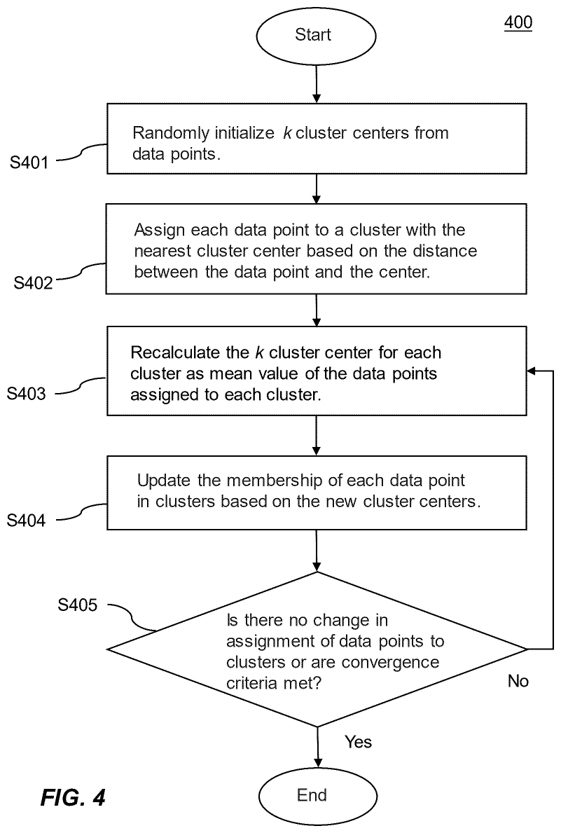

With reference to FIG. 4, shown is a workflow diagram of a clustering method 400 that may be used for the disclosed invention. There may be many clustering algorithms that can be used to cluster images into a defined number of clusters based on embedding models that are used to generate the image embeddings. An example of a clustering algorithm is the K-means clustering algorithm. The K-means clustering algorithm is used to cluster embeddings into a set number of categories. The method 400 may represent the K-means clustering algorithm. The K-means clustering algorithm may be used to partition the image embeddings 231-233. K-means clustering partitions the data points into k clusters, where each data point belongs to the cluster with the nearest mean. Herein, the data points in the method 400 are image embeddings 231-233.

Referring to FIG. 4, the clustering algorithm starts by randomly initializing k cluster centers from the data points, block S401. Then, each data point is assigned to the cluster with the nearest cluster center based on the distance between the data point and the cluster center, block S402. Criteria for determining the nearest cluster, such as a predetermined distance, may be provided for the data points. The k cluster center for each cluster is then recalculated as the mean value of the data points assigned to each cluster, block S403. The membership (assignment) of each data point is then updated based on these recalculated new cluster centers, block S404. In other words, in this step, each data point is reassigned to the cluster with the nearest new cluster center based on the distance between the data point and the new cluster center. With the new assignments of the data points to clusters, it is determined whether the assignments of data points to clusters have been changed from the previous assignments or whether predetermined convergence criteria are met, block S405. If the assignments of data points to clusters have been changed and the predetermined criteria are not met, the processes in blocks S403-S404 repeat. New cluster centers are recalculated 6 based on the new assignments of the data points, until the assignments of data points to clusters no longer change or until the predetermined convergence criteria are met.

The number of clusters, k, may be determined based on the application. The user may be allowed to determine the number of clusters, k, as a fraction of the total dataset that is to be pruned. For example, by specifying a fraction of 0.01 and applying it to a dataset of 20,000 images, the algorithm initializes a total of 200 clusters. K-means clustering has an advantage in that it is easy to interpret, relatively fast, and scalable. The open-source Python machine learning library SciKit-Learn may be used to implement the clustering algorithm.

Returning to FIG. 1, once the clustering process S103 is completed, there will be k clusters, each of which contains a certain number of image embeddings. The selecting process is the step to select images from each cluster to create a diverse subset for Active Learning models. To effectively prune the dataset, a target selection number, which is a total number of images to be selected from the clusters, is set, block S104. The target selection number is the number of images that will be contained in the diverse subset. The user may provide the target selection number, or the system may set the target selection number based on applications. The predetermined target selection number may be given as a percentage of the total number of images in the initial image set.

Once the target selection number is set, the next step is to determine the number of images to be selected from each cluster, which is referred to as the selection number for each cluster. The sum of the selection numbers of all clusters will be the same as the target selection number. There may be various methods to determine the selection numbers for the clusters. In the disclosed invention, the selection number for each cluster is obtained based on internal diversity. In an embodiment, in order to account for the intra-cluster diversity, the selection number for each cluster is weighted by a metric of internal diversity. An example of a metric of the internal diversity is the comparative radius of a cluster. When the selecting step is weighted by this metric, the number of images to be selected from clusters is obtained according to the following equation:

$${N}_{i} = \frac{{R}_{i}}{{\sum }_{k} {R}_{k}} I \qquad ( 1 )$$

where Ni is the selection number for the cluster i, Ri is the radius of the cluster i, I is the desired selection number of images (target selection number), and Σₖ Rₖ is the sum of all radii of the clusters. Rᵢ/(Σₖ Rₖ) may be referred to as a normalized radius of the cluster i. For example, consider a simple case with three clusters: Cluster 1 includes 100 images with radius 0.24, Cluster includes 150 images with radius 1.1, and Cluster 3 includes 50 images with radius 0.5. The total number of images within Clusters 1, Cluster 2 and Cluster 3 is 300. Suppose that the target selection number is 100. The selection numbers from each cluster are calculated below.

$${N}_{1} = \frac{{R}_{1}}{( {R}_{1} + {R}_{2} + {R}_{3} )} I = \frac{0.24}{( 0.24 + 1.1 + 0.5 )} 100 = 13.0434782609 \approx 13 \qquad ( 2 )$$

$${N}_{2} = \frac{{R}_{2}}{( {R}_{1} + {R}_{2} + {R}_{3} )} I = \frac{1.1}{( 0.24 + 1.1 + 0.5 )} 100 = 59.7826086957 \approx 60 \qquad ( 3 )$$

$${N}_{3} = \frac{{R}_{3}}{( {R}_{1} + {R}_{2} + {R}_{3} )} I = \frac{0.5}{( 0.24 + 1.1 + 0.5 )} 100 = 27.1739130435 \approx 27 \qquad ( 4 )$$

In this example, 100 images are selected to create the diverse subset: 13 images from Cluster 1, 60 images from Cluster 2, and 27 images from Cluster 3. Notice that, although Cluster 3 contains a smaller number of total images than Cluster 1, more images are selected for the diverse subset from Cluster 3 than Cluster 1. This is because Cluster 3 has a greater radius than Cluster 1, and therefore has greater internal diversity than Cluster 1.

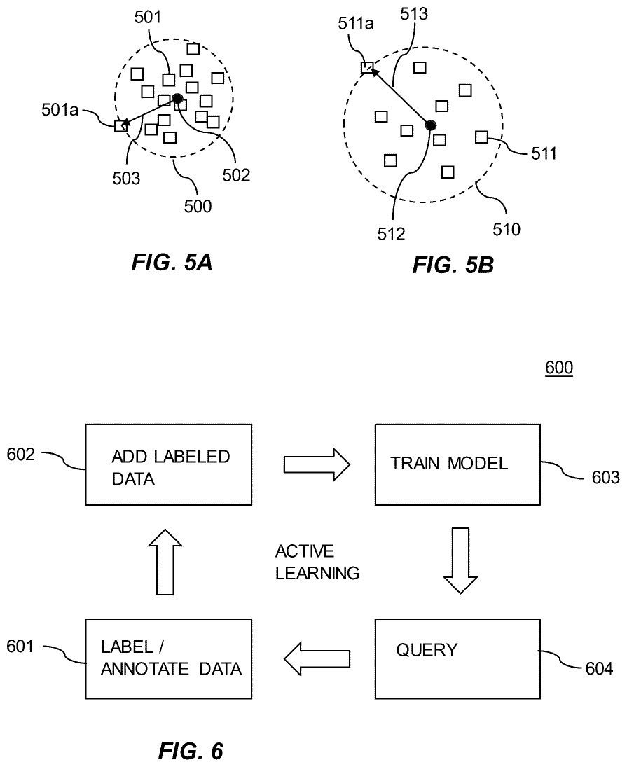

With reference to FIGS. 5A-5B, shown are exemplary diagrams illustrating a definition of the radius of a cluster. For example, the radius of a cluster may be defined as a distance from the cluster center to the farthest image embedding contained in the cluster. As shown in FIG. 5A, cluster 500 has a plurality of images 501 represented by image embeddings. The image 501a among the images 501 is the farthest image from the cluster center 502. The radius 503 of the cluster 500 is defined as the distance from the cluster center 502 to the farthest image 501a. In the same way, the radius 513 of cluster 510 is defined as the distance from the cluster center 512 to the farthest image 511a among images 511 in the cluster 510. As shown in FIGS. 5A-5B, the images 511 in the cluster 510 are more diversly distributed than the images 501 in the cluster 500, which indicates that the cluster 510 has higher internal diversity than the cluster 500. The internal diversity represents a variety of distinctions or differences within otherwise clustered or grouped images. In other words, the internal diversity is such that it captures the variations or dissimilarities among similar images that are grouped together. Images within the same cluster or grouping are expected to be similar in some sense, but the internal diversity quantifies the degree of variation or heterogeneity present within that group.

When the image embedding is a multi-dimensional vector, the definition of the radius of the cluster is contingent upon the type of distance metric used. For example, if the Euclidean distance is used, the radius of the cluster is defined according to the following equation.

$$r = \sqrt{{( {e}_{1} - {c}_{1} )}^{2} + {( {e}_{2} - {c}_{2} )}^{2} + … + {( {e}_{d} - {c}_{d} )}^{2}} \qquad ( 5 )$$

where r is a radius, e=(e₁, e₂, . . . ed) is a vector image embedding of the farthest image, c=(c₁, c₂, . . . c_{d}) is the center of the cluster in which the vector e is contained, and d is a dimension of the vector. As another example, if the Cosine distance is used, the radius of the cluster would be defined as:

$$r = \frac{1 - ( {e}_{1} {c}_{1} + {e}_{2} {c}_{2} + … + {e}_{d} {c}_{d} )}{\sqrt{{e}_{1}^{2} + {e}_{2}^{2} + {e}_{d}^{2}} \sqrt{{c}_{1}^{2} + {c}_{2}^{2} + … + {c}_{d}^{2}}} \qquad ( 6 )$$

However, the definition of the radius of a cluster may not be limited to these definitions described above and shown in FIGS. 5A-5B. The choice of the distance can differ based on the specific requirements of the problem at hand. Many different definitions of distance may be valid in conjunction with this approach, including but not limited to Euclidean, Cosine, Manhattan, and Minkowski. The radius of a cluster is a parameter that determines overall size or volume of the cluster, and the radius of a cluster may be defined differently to properly represent the size or volume of the cluster.

In the embodiment described above, a comparative radius of a cluster is used as the metric of the internal diversity. However, other metrics may be used as the metric of the internal diversity of the disclosed invention. Examples of possible other metrics include Cluster Diameter, Intra-Cluster Variance, Average Centroid Distance, Average Pairwise Distance, and Cluster Tightness.

Cluster diameter is defined as the maximum distance between any two data points within the cluster. A higher value can indicate that data points are spread out over a wider range, suggesting greater internal diversity.

Intra-Cluster Variance is computed as the sum of squared distances between each vector and the cluster centroid, divided by the total number of vectors in the cluster. It provides a measure of how tightly the points are clustered around the centroid, with higher values indicating greater internal diversity.

Average Centroid Distance is defined as the average distance between the cluster centroid and all data points in the cluster. It provides a measure of how tightly the points are clustered around the centroid, with higher values indicating greater internal diversity.

Average Pairwise Distance is the average distance between all pairs of data points in the cluster. It provides a measure of how closely the data points in the cluster are packed together, with higher values indicating greater internal diversity.

Cluster tightness is the ratio of the sum of distances between each data point and the cluster centroid to the sum of distances between each pair of data points. It provides a measure of how closely the data points in the cluster are packed together, with lower values indicating greater 11 internal diversity.

In the disclosed invention, any of these metrics may be used to obtain the selection number for each cluster in the step S105. Once the selection number for each cluster is obtained in the step S105, some images among the images in each cluster are selected based on the selection number for each cluster, block S106. There may be various methods to select images from each cluster. In an embodiment, the images are randomly selected among the images in the cluster. Once images are selected from the clusters, a diverse subset is generated with these selected images, block S107. The diverse subset is ready to be used to train Active Learning models. Data pruning described above aims to reduce the size of a dataset while preserving its representative and discriminative properties. Data pruning can improve the interpretability and generalization of models trained on the data.

With reference to FIG. 6, shown is an exemplary diagram illustrating an Active Learning (AL) loop 600. AL is a machine learning technique that focuses on maximizing a model's performance gain while requiring the least amount of labeled data necessary. AL may include steps, for example, labeling/annotating data (samples), step 601, adding labeled data to the training data set, step 602, training the model using the updated training data set, step 603, and querying, step 604, to select the next set of data (samples) for labeling. The querying step 604 is crucial for selecting the next most informative samples to include in the model's training data. This selection can be performed randomly or through a querying strategy.

An example of a querying strategy that may be used is Least Confidence Sampling. In this approach, a model's prediction confidence (e.g., the probability of the most likely class) is calculated for each remaining unlabeled sample. The samples with the lowest prediction confidence are then selected for labeling/annotating, step 601. The underlying assumption is that the model is most uncertain about the samples for which it has the least confidence in its predictions. Another example of a querying strategy that may be used is Margin Sampling. This strategy selects the samples for which the difference between the two most likely class probabilities (the margin) is smallest. In other words, it selects the samples for which the model's top two predictions are closest or most confusing. The smaller the margin, the higher the uncertainty, and the more valuable the sample is expected to be for improving the model's decision boundary. Yet another example of a querying strategy that may be used is Adversarial Sampling. This strategy takes a more adversarial approach by selecting the samples that are most likely to cause the model to make mistakes or be misclassified. The idea is to identify the samples that are most challenging or adversarial for the current model, with the goal of improving its robustness and generalization ability.

The querying strategy may not be limited to any of these definitions and may be chosen based on the specific requirements and characteristics of the desired trained model. The type of query strategy for determining the next data (samples) to label/annotate may be predetermined before the AL loop begins. In the AL process, the steps 601-604 may repeat to improve the AL model's performance. The diverse subset generated in block S107 is used to train an AL model, block S108, for example, through the AL loop 600 shown in FIG. 6.

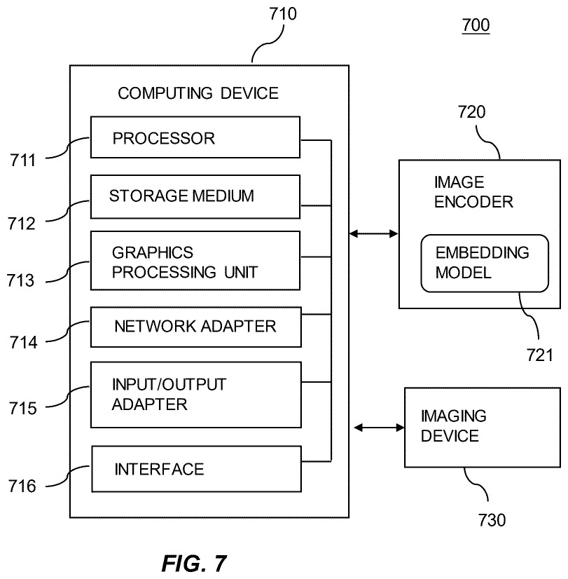

With reference to FIG. 7, shown is a diagram of a system 700 of the disclosed invention for data pruning to create a diverse subset of images from an initial dataset of images to train Active Learning models. The system 700 includes at least one computing device 710 such as computers and servers. The computing device 710 includes at least one processor 711 and one or more non-transitory computer readable storage media 712. The computing device 710 may include one or more graphics processing units (GPU) 713 to accelerate image processing. The computing device 710 further includes at least one network adapter 714 for data communications through networks, at least one input/output adapter 715 for additional data communications and graphic user interfaces (GUI), and one or more interfaces 716 to communicate with external computer devices. The system 700 further includes image encoder 720 that may include at least one embedding model 721.

The image encoder 720 is coupled to the computing device 710 and is configured to receive images 220 (see FIG. 2A) from the computing device 710. The image encoder 720 may store predetermined image embeddings of a plurality of images and may use embedding model 721 to compute the image embeddings 231-233 of the images 221-223 received from the computing device 710. The image encoder 720 may be a computer device, such as computers and servers, which includes at least one processor (not shown) and one or more non-transitory computer 8 readable storage media (not shown) that store instructions causing the processor to perform its own functions such as computing image embeddings of images. The computing device 710 receives image embeddings of the images from the image encoder 720.

Optionally, the system 700 may include at least one imaging device 730, such as cameras and video recorders, to capture images and/or videos of objects and scenes. The imaging device is coupled to the computing device 710 and provides the computing device 710 with the captured images and/or videos. The captured images and/or videos transferred to the computing device 710 may be included in an initial dataset of images from which a diverse subset for Active Learning models can be created. The computing device 710 may actively control the imaging 17 device 730 to capture images and/or videos and to receive the captured images and/or videos.

The one or more storage media 712 of the computing device 710 store instructions to perform the overall processes of data pruning, as shown in FIG. 1, to create a diverse subset of images from an initial dataset of images to train Active Learning models. The instructions cause the at least one processor 711 to execute operations for data pruning, which includes receiving the initial dataset of images to be pruned, creating, via the image encoder, image embeddings of images of the initial dataset of images, performing clustering with the image embeddings to create a plurality of clusters that contain the image embeddings, setting a target selection number of images which is to be contained in the diverse subset, obtaining a selection number for each cluster based on internal diversity of the clusters, selecting images among images in each cluster based on the selection number for each cluster, and generating the diverse subset with the selected images. The selection number for each cluster is obtained based on internal diversity of the clusters, which represents a variety of distinctions or differences within otherwise clustered or grouped images.

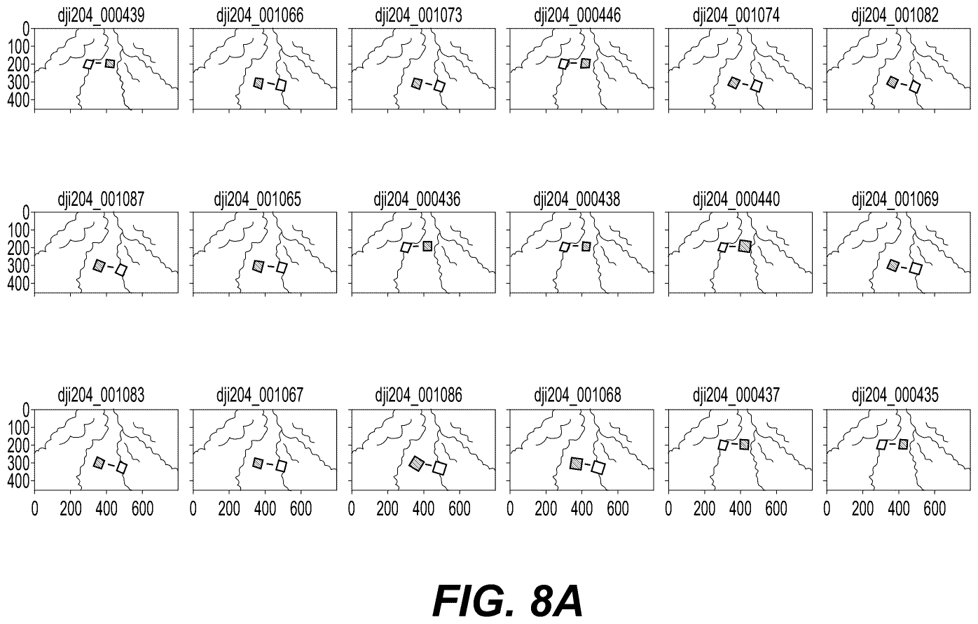

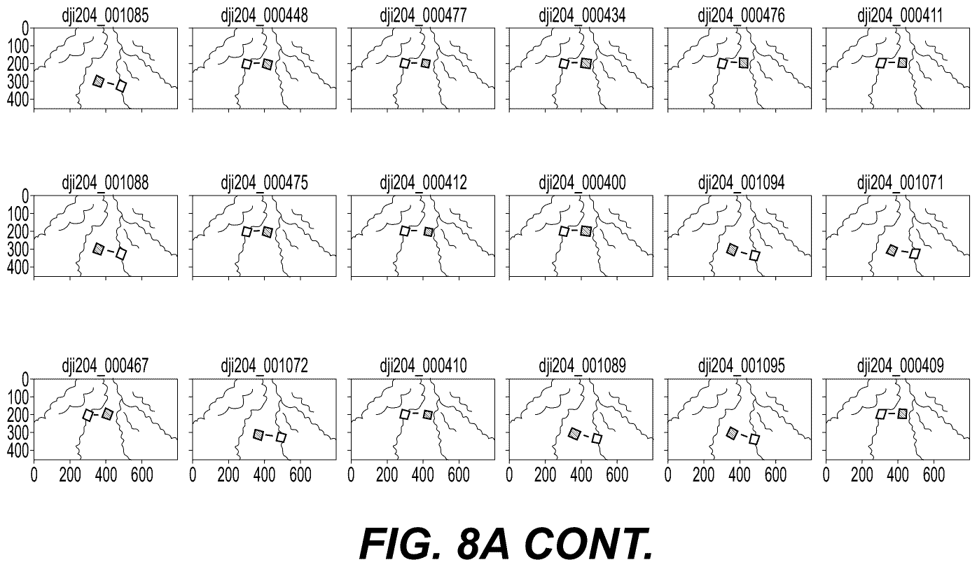

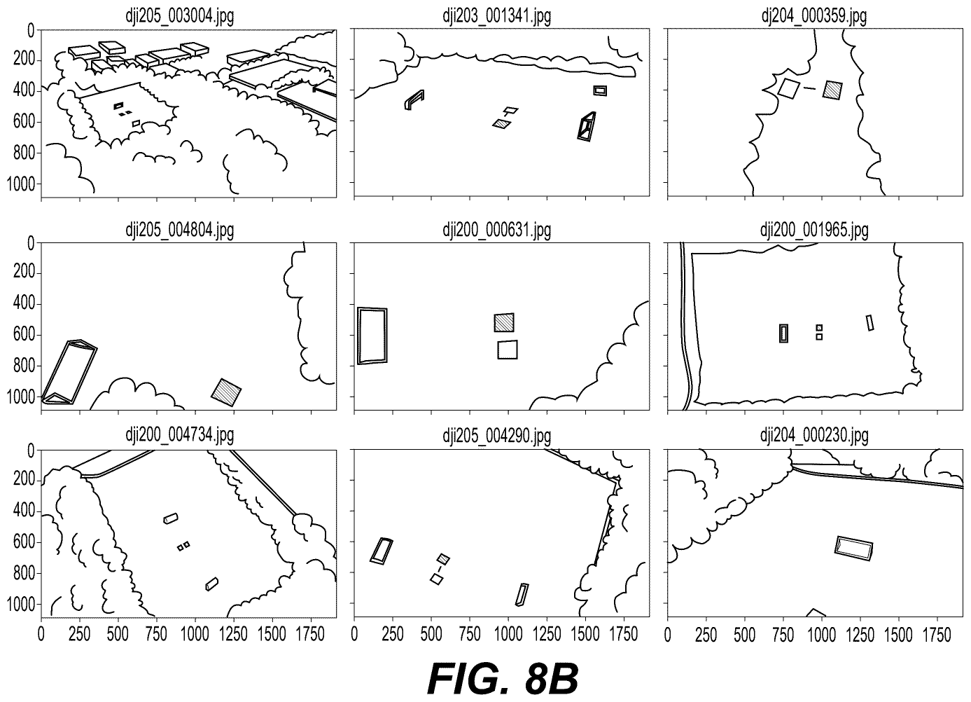

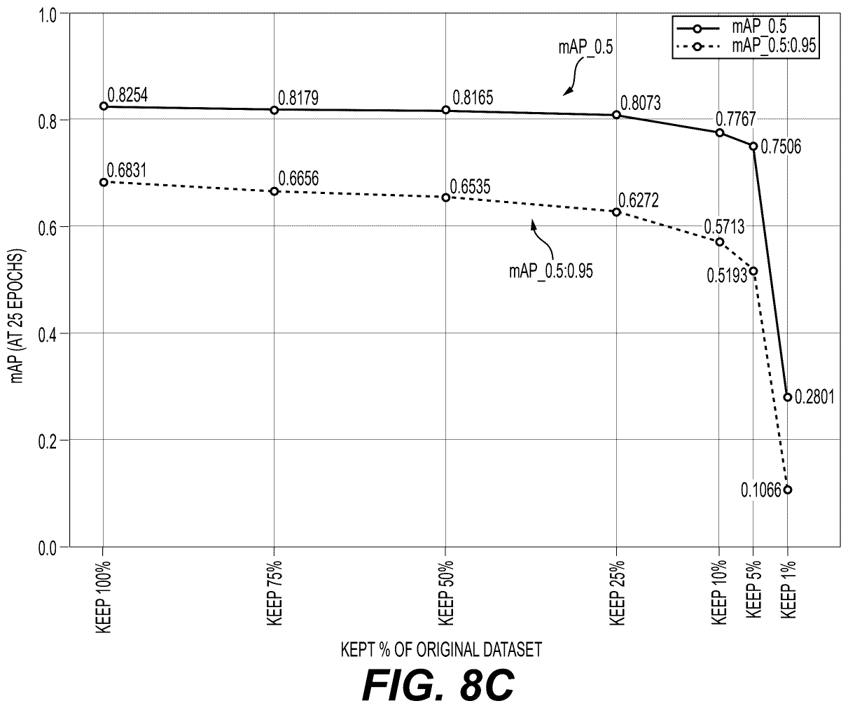

With reference to FIG. 8A, shown is an example of a group of highly similar images. While minor variations between images are present, they are not influential enough to warrant labelling and including every image in the group into a model's training set. An intelligent sampling of these images is necessary to maximize a model's information gain from these images while needing to label and incorporate as few images as possible.

With reference to FIG. 8B, shown is an example of a group of diverse images obtained by using the method and system of the disclosed invention. These images were obtained from the same initial dataset that the images in FIG. 8A were taken from. Variations between the images in the group are influential enough to warrant labeling and including every image in this group into a model's training set.

With reference to FIG. 8C, shown is a chart showing performance (mAP) of a YoloV5N model as trained on variously sized diverse subsets of an internal twenty thousand image dataset using the method and system of the disclosed invention. The chart in FIG. 8C shows that 95% of the dataset can be pruned before the impact to performance becomes substantial. It should be noted that, while FIG. 8C demonstrates the efficacy of this method using a Yolo V5N model, the selection of this model was arbitrary, and the applicability of the method and system of the disclosed invention is not limited to the scope of YoloV5N models.

The disclosed invention provides advantages over the known methods described in the Background section. For example, Forgetting Scores determines the significance of a training sample by tracking how often it is forgotten during the training process. However, since Forgetting Scores depend on labels to make their calculations, they are only applicable to labeled data. Additionally, forgetting scores are computed during model training and therefore require a model to be trained before pruning can occur. Memorization Scores calculates memorization scores for each training sample based on how much inclusion of the sample improves the accuracy of predicting the label for every given test sample. Memorization scores have been proposed for use in informing data pruning. However, their high computational cost makes them impractical. Additionally, memorization scores can only be computed for labeled data.

Error L2-Norm (EL2N) Scores computes scores for each training sample by training small ensembles of neural networks and using the ensembles to calculate the average L2 norm of the error vector for each training sample. EL2N scores rely on labels for their calculation and therefore are only calculable for labeled data. In contrast, the disclosed invention relies on a pre-trained OpenCLIP image encoder and a simple K-means clustering algorithm and does not incur the overhead of training and aligning the results from ensembles of neural networks. Additionally, the method of the disclosed invention is self-supervised and works for unlabeled data.

The disclosed invention is self-supervised and does not rely on labels to prune data. This is a huge advantage, as it makes the approach more versatile and applicable to a wider range of scenarios. Furthermore, this technique prunes data before training, resulting in no computational expenses linked with training a model to perform data pruning. The disclosed invention utilizes an efficient image encoder (OpenCLIP) and a fast clustering algorithm (K-means), resulting in low computational cost. Additionally, this approach works on both unlabeled and labeled data.

A recent approach, published in Sorscher, B., Geirhos, R., Shekhar, S., Ganguli, S., Morcos, A. S., “Beyond neural scaling laws: beating power law scaling via data pruning,” 36th Conference on Neural Information Processing Systems (NeurIPS 2022), proposed using a clustering algorithm to group samples together based on their similarity and quantified the difficulty of learning each sample by the cosine distance from the sample to the centroid of the cluster that it belongs to. The easiest samples (those closest to the cluster centroids) can be pruned. This approach used the embedding space of an ImageNet pre-trained SWaV model with a ResNet50 backbone to define similarity and K-means clustering to group samples. This approach uses a nongeneralizable class of models (ResNet) to generate the embedding space. ResNet models are trained on specific image classification tasks and predetermined visual concepts. This restricts their generality and results in poor performance on tasks and concepts they were not explicitly trained for.

In contrast, embedding models, such as CLIP models, are trained on extremely large and diverse datasets that use raw text describing images as a source of supervision. This makes CLIP models more robust and able to generalize better to new and unseen tasks and concepts. Due to their generality, CLIP models generate a more discriminative embedding space than ResNet models. The disclosed invention is designed to increase the efficiency of the model improvement cycle for machine learning models by using a novel data pruning approach to reduce the annotation effort required for unlabeled vision datasets. The disclosed invention uses a robust, generalizable model, such as OpenCLIP, to generate the embedding space.

Moreover, the disclosed invention proposes the novel heuristic of weighting the selection of images by a metric of internal diversity such as the radius of the cluster being selected from, allowing more images to be sampled from clusters that have a greater radius (and, therefore, are more internally diverse). This heuristic is added to improve the overall diversity of the selected images and prevent the over-representation of similar images. By sampling more images from clusters that are more internally diverse, the approach is able to better represent the overall distribution of the data, improving the quality of the resulting dataset. This allows the disclosed invention to be more versatile and applicable to nearly any vision dataset annotation task without the need for dataset specific training. Additionally, in contrast to the recent approach, which focuses solely on pruning “easy” examples, the disclosed invention allows for greater flexibility in the selection of data to be pruned. With the method of the disclosed invention, a specific percentage of the dataset, rather than just the easy examples, can be chosen. This is made possible by the disclosed invention's introduction of a novel heuristic that involves weighting the number of images selected from a cluster using a metric of internal diversity such as the radius of the cluster. By favoring clusters with a larger radius, which indicates greater internal diversity, the disclosed invention can select a more representative subset of the data for pruning, resulting in improved performance.

In addition to the above advantages, the disclosed invention also provides an advantage of cost reduction. The cost depends on several factors: the amount of data, the diversity of data, and the desired final accuracy of the model. In the absence of data pruning, the optimal strategy to guarantee models that can train to high accuracy from scratch is to label all data in the dataset. Labelling all data in the dataset may incur high cost. However, by using efficient and reliable data pruning, the cost may be reduced dramatically. For example, see FIG. 8C showing the performance of a model trained on variously sized diverse subsets of an internal twenty thousand image dataset created using the method of the disclosed invention. The chart in FIG. 8C shows that 95% of the dataset can be pruned before the impact to performance becomes substantial, which indicates that the cost may be reduced by 95%. By needing to label orders of magnitude fewer data, the time between data collection and model delivery is greatly reduced, allowing for more rapid iterations of testing and identifying model limitations. The discovery of such limitations can lead to more efficient data collection. During the testing of the disclosed invention, the labeling time was reduced by up to ten times, from two weeks to one day. This also results in about ten times more model iterations, which has an outsized impact on the final real-world value of the model.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A method for data pruning to create a diverse subset to train Active Learning (AL) models, comprising:
preparing an initial dataset of images to be pruned;
creating, via an image encoder, image embeddings of images of the initial dataset of images, wherein the image embeddings include numeric representations of the images and are constructed to represent similarities of the images;
performing clustering with the image embeddings to create a plurality of clusters that contain the image embeddings;
setting a target selection number of images which is to be contained in the diverse subset;
obtaining a selection number for each cluster based on internal diversity of clusters, wherein the internal diversity represents a variety of distinctions or differences within otherwise clustered or grouped images;
selecting images among images in each cluster based on the selection number for each cluster;
generating the diverse subset with the selected images; and
training the Active Learning (AL) models with the generated diverse subset.

2. The method of claim 1 wherein a metric of the internal diversity comprises a radius of each cluster.

3. The method of claim 1 wherein the obtaining the selection number for each cluster comprises computing the target selection number weighted by a radius of the cluster.

4. The method of claim 3 wherein the selection number is calculated by:
$${N}_{i} = \frac{{R}_{i}}{{\sum }_{k} {R}_{k}} I$$
where Ni is the selection number for a cluster i, Ri is the radius of the cluster i, and I is the target selection number.

5. The method of claim 3 wherein the radius of the cluster is a distance between a center of the cluster and the farthest image embedding contained in the cluster.

6. The method of claim 1 wherein the image embeddings comprise multi-dimensional vectors.

7. The method of claim 1 wherein the selecting images among images in each cluster comprises randomly selecting images in each cluster by the selection number.

8. The method of claim 1 wherein the performing clustering comprises:
setting a number of clusters;
initialize centers of clusters;
assigning each image embedding to a cluster based on a distance between the image embedding and the center of the cluster;
recalculating the centers of the clusters as a mean value of the image embeddings assigned to each cluster;
updating the assignment of each image embedding in clusters based on the recalculated centers of the clusters; and
repeating recalculating the centers of the clusters and the updating the assignment of each image embedding until there is no change in the assignment of the image embeddings to the clusters or until predetermined convergence criteria are met.

9. A system for data pruning to create a diverse subset to train Active Learning (AL) models, comprising:
at least one image encoder that stores image embeddings of a plurality of images, wherein the image embeddings include numeric representations of the images and are constructed to represent similarities of the images;
at least one computing device coupled to the at least one image encoder to perform image embeddings of images of an initial dataset of images, wherein the at least one computing device comprises at least one processor and one or more non-transitory computer readable media including instructions that cause the at least one processor to execute operations for data pruning to create the diverse subset, the operations comprising:
receiving the initial dataset of images to be pruned;
creating, via the image encoder, image embeddings of images of the initial dataset of images;
performing clustering with the image embeddings to create a plurality of clusters that contain the image embeddings;
setting a target selection number of images which is to be contained in the diverse subset;
obtaining a selection number for each cluster based on internal diversity of clusters, wherein the internal diversity represents a variety of distinctions or differences within otherwise clustered or grouped images;
selecting images among images in each cluster based on the selection number for each cluster;
generating the diverse subset with the selected images; and
training the Active Learning (AL) models with the generated diverse subset.

10. The system of claim 9 wherein a metric of the internal diversity comprises a radius of each cluster.

11. The system of claim 9 wherein the obtaining the selection number for each cluster comprises computing the target selection number weighted by a radius of the cluster.

12. The system of claim 11 wherein the selection number is calculated by:
$${N}_{i} = \frac{{R}_{i}}{{\sum }_{k} {R}_{k}} I$$
where Ni is the selection number for each cluster i, Ri is the radius of the cluster i, and/is the target selection number.

13. The system of claim 11 wherein the radius of the cluster is a distance between a center of the cluster and the farthest image embedding contained in the cluster.

14. The system of claim 9 wherein the image embeddings comprise multi-dimensional vectors.

15. The system of claim 9 wherein the selecting images among images in each cluster comprises randomly selecting images in each cluster by the selection number.

16. The system of claim 9 wherein the performing clustering comprises:
setting a number of clusters;
initialize centers of clusters;
assigning each image embedding to a cluster based on a distance between the image embedding and the center of the cluster;
recalculating the centers of the clusters as a mean value of the image embeddings assigned to each cluster;
updating the assignment of each image embedding in clusters based on the recalculated centers of the clusters; and
repeating the recalculating the centers of the clusters and the updating the assignment of each image embedding until there is no change in the assignment of the image embeddings to the clusters or predetermined convergence criteria are met.

17. The system of claim 9 further comprising one or more imaging devices configured to capture images and/or videos of objects or scenes.

18. The system of claim 17 wherein the receiving the initial dataset of images comprises receiving the captured images and/or videos from the one or more imaging devices.
